(19) United States
(12) Patent Application Publication
(10) Pub. No.: US 2015/0097091 A1
(43) Pub. Date: Apr. 9, 2015

(54) GRAVITY HAMPER LAUNDRY CENTER

(71) Applicant: Whitmor, Inc., Southhaven, MS (US)

(72) Inventors: Sandy Felsenthal, Memphis, TN (US); Milton D. Ruiz, Germantown, TN (US)

(21) Appl. No.: 14/508,869

(22) Filed: Oct. 7, 2014

Related U.S. Application Data
(60) Provisional application No. 61/887,770, filed on Oct. 7, 2013.

(51) Int. Cl. B65B 67/12; B62B 3/00

(52) U.S. Cl. CPC B65B 67/12; B65B 67/1233; B62B 3/005; B65B 2067/1294
USPC 248/97

(57) ABSTRACT

A hamper support system herein includes a single horizontal support bar, and at least one anchor hook that has an upper and a lower section. A hamper bag frame may also be included, which can be selectively engaged with and disengaged from the horizontal support barvia the anchor hook to enable easy transportation of the attached hamper bag. The anchor hook may be connected to the horizontal support bar via the lower section and may receive and support the hamper bag frame with the upper section. When a portion of the hamper bag frame is placed below the upper section of the anchor hook and adjacent portions of the hamper bag frame are positioned over the horizontal support bar, the hamper bag frame is held in a secure position such that the attached hamper bag is able to be filled. The hamper bag and frame can then be easily removed from the horizontal support bar to facilitate easy transportation of the hamper contents to another location by releasing the hamper bag frame from the upper section of the anchor hook.

### CROSS-REFERENCE TO RELATED APPLICATIONS

This application claims priority to U.S. Provisional Patent Application No. 61/887,770, filed Oct. 7, 2013, the entire disclosure of which is hereby incorporated by reference herein.

### BACKGROUND OF THE INVENTION

Conventional multiple-bin laundry hampers include more than one bin, and each bin is attached to a laundry hamper bag. Multiple-bin laundry hampers typically include between two and four bins. A person can store and sort goods to be laundered in the multiple-bin laundry hamper according to the respective care instructions of the goods. Often, the laundry bags are detachable so that the laundry hamper itself can remain stationary and the bags are removable. As a result, the bags can be taken to and from laundry machines conveniently.

Presently, multiple-bin laundry hampers are ordinarily supported by a rectangular frame. If the multiple-bin laundry hampers are not supported by a rectangular frame, they are often supported by two parallel horizontal bars. A rectangular frame or a parallel-bar arrangement adequately supports the multiple-bin laundry hamper; however, it does so inefficiently.

Multiple-bin laundry hampers supported by a rectangular frame or parallel horizontal bars require significant manufacturing processes and present challenging packaging constraints. Furthermore, multiple-bin laundry hampers supported by a rectangular frame or parallel horizontal bars create a burdensome assembly process for the consumer. Therefore, it is desirable to provide a multiple-bin laundry hamper supported by a single horizontal bar, so as to reduce the impact on manufacturing, packaging, and simplify consumer assembly.

### BRIEF SUMMARY OF THE INVENTION

In one embodiment, as embodied and broadly described here, the present invention may include a hamper support system made up of a single horizontal support bar, and at least one anchor hook that has an upper and a lower section. A hamper bag frame may also be included, which can be selectively engaged with and disengaged from the horizontal support bar via the anchor hook to enable easy transportation of the attached hamper bag. The anchor hook may be connected to the horizontal support bar via the lower section and may receive and support the hamper bag frame with the upper section. When a portion of the hamper bag frame is placed below the upper section of the anchor hook and adjacent portions of the hamper bag frame are positioned over the horizontal support bar, the hamper bag frame is held in a secure position such that the attached hamper bag is able to be filled. The hamper bag and frame can then be easily removed from the horizontal support bar to facilitate easy transportation of the hamper contents to another location by releasing the hamper bag frame from the upper section of the anchor hook.

In another embodiment, a single-bar hamper support system may comprise a horizontal support bar. The system may also include at least one anchor hook which has a vertical portion. The vertical portion may include an upper section and a lower section, and may be connected with the horizontal support bar via said lower section. At least one hamper bag frame may also be included. The anchor hook may be operable for supporting the hamper bag frame on the horizontal support bar when a first portion of said hamper bag frame is positioned beneath the upper section of said anchor hook, and second portions of the hamper bag frame (which are adjacent to said first portion) are positioned over said horizontal support bar.

In another embodiment, a single-bar hamper support system may comprise a horizontal support bar. The system may also include at least one anchor hook which has a first section extending generally vertically from the horizontal support bar to a distal end of the first section. The anchor hook may also include a second section extending generally horizontally from the distal end of the first section. The first and second sections of the at least one anchor hook may therefore form a generally L shape. The system may also include at least one hamper bag frame positioned on top of the horizontal support bar and below the second section of the anchor hook.

### BRIEF DESCRIPTION OF THE DRAWINGS

FIG. 1 is a perspective view of a single-bar hamper support system according to an embodiment of the present invention.

FIG. 2 is a perspective view of a hamper bag frame aligned for attachment with the upper recess of an anchor hook attached to a horizontal support bar.

FIG. 3 is a perspective view of a three-bin gravity hamper according to an embodiment of the present invention.

FIG. 4 is a perspective view of a four-bin gravity hamper according to an embodiment of the present invention.

FIG. 5 is a perspective view of a three-bin gravity laundry and folding hamper according to an embodiment of the present invention.

FIG. 6 is a perspective view of a three-bin gravity hamper laundry center according to an embodiment of the present invention.

While the disclosure is susceptible to various modifications and alternative forms, specific embodiments thereof are shown by way of example in the drawing and will herein be described in detail. It should be understood, however, that the drawings and detailed description presented herein are not intended to limit the disclosure to the particular embodiment disclosed, but on the contrary, the intention is to cover all modifications, equivalents, and alternatives falling within the spirit and scope of the present disclosure as defined by the appended claims.

### DETAILED DESCRIPTION OF THE INVENTION

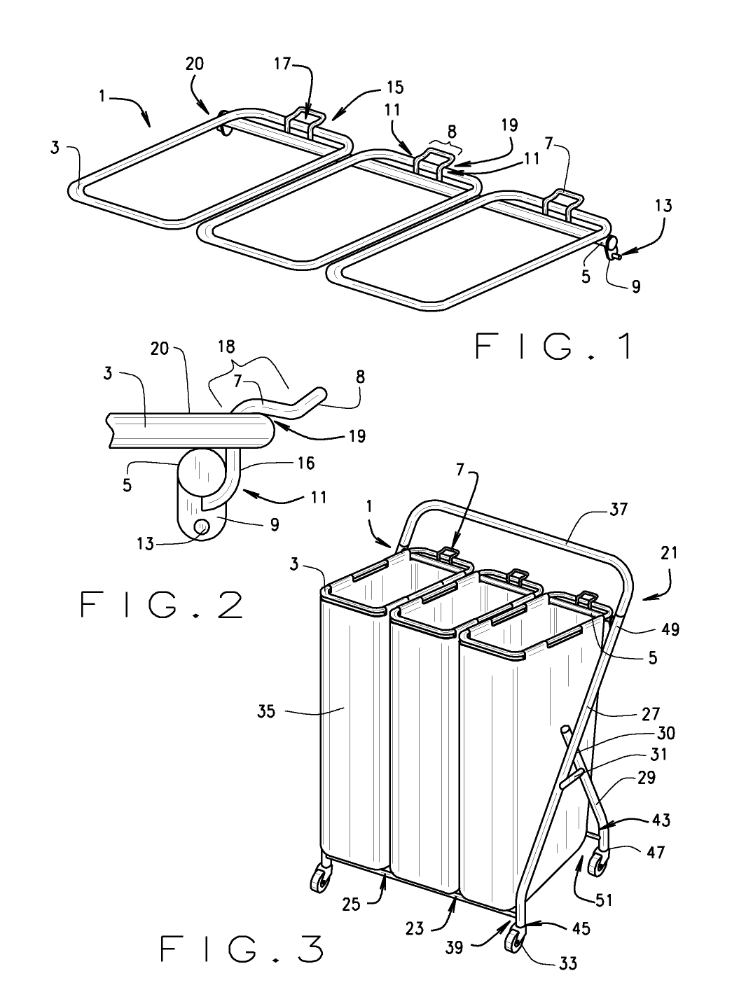

Referring to the drawings particularly by reference numbers wherein like numerals refer to like parts, FIG. 1 illustrates a single-bar hamper support system 1. In the present embodiment, the single-bar hamper support system 1 includes three hamper bag frames 3, a horizontal support bar 5, three anchor hooks 7, and two attachment pegs 9. In the present embodiment, the hamper bag frames 3, horizontal support bar 5, anchor hooks 7, and attachment pegs 9 may be made from coated steel. In the preferred embodiment, the number of hamper bag frames 3 and anchor hooks 7 will be equal. For example, in the present embodiment, the single-bar hamper support system 1 includes three hamper bag frames 3 and three anchor hooks 7.

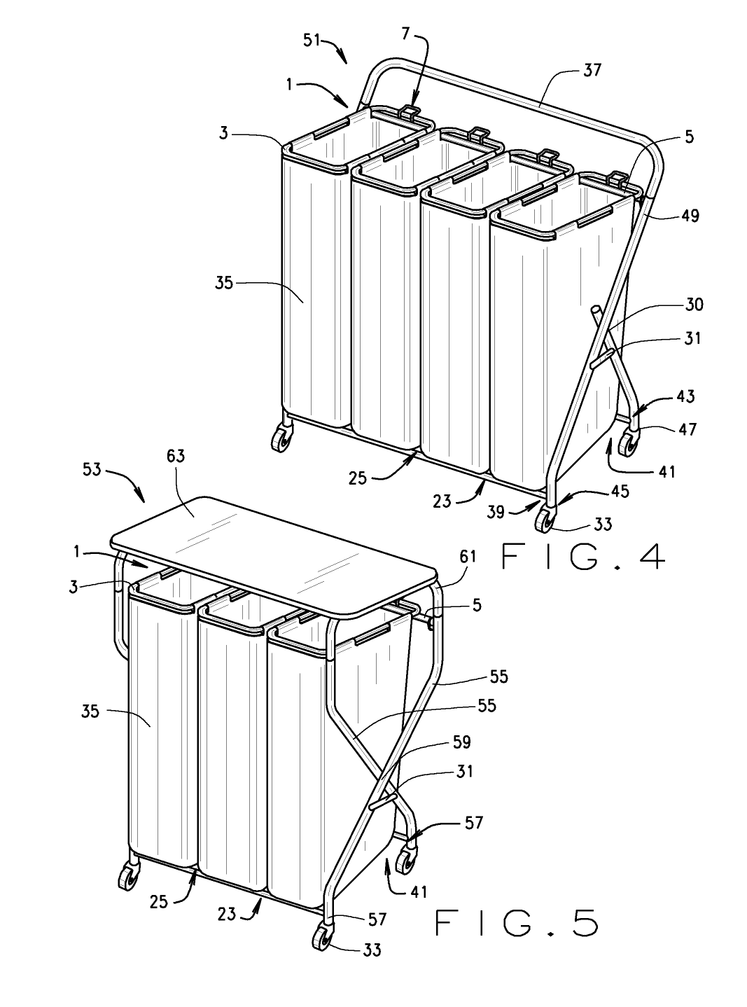

In the present embodiment, the anchor hooks 7 are preferably C-shaped having an S-shaped vertical portion 11 on either side of a horizontal portion 8. As illustrated in FIG. 2, the lower section 16 of each vertical portion 11 of the respective anchor hooks 7 may be wrapped around the horizontal support bar 5 and welded to the horizontal support bar 5 (although mechanisms for affixing an anchor hook 7 with the horizontal support bar 5 are also envisioned, including but not limited to screws, bolts, and the like). As FIG. 2 further illustrates, the upper section 18 of each vertical portion 11 of the anchor hooks 7 define an upper recess 19 for receiving and securing a section of the hamper bag frame 3. The three anchor hooks 7 are preferably welded onto the horizontal support bar 5 such that they are equally spaced from the other anchor hooks 7, and when the hamper bag frames 3 are attached to the anchor hooks 7, the hamper bag frames 3 are adjacent to one another. A single S-shaped vertical portion 11 of the anchor hook 7 could effectively receive and retain the hamper bag frame 3 without a horizontal portion 8 or a second vertical portion 11. As would be understood, any flange having a generally vertical portion extending from the horizontal support bar 5 (e.g., lower section 16), and a generally horizontal portion (e.g., upper section 18) extending from the generally vertical portion could be sufficient to receive and retain the hamper bag frame 3. The embodiment illustrated in the Figures and described above of the anchor hook 7 noted above having two S-shaped vertical portions 11 connected by a horizontal portion 8 is just one example structure, and may provide desirable additional load support and stability. The attachment pegs 9 are attached to the distal ends of the horizontal support bar 5 such that the protruding portions 13 of attachment pegs 9 are facing radially outward from the horizontal support bar 5 such that the protruding portions 13 can interlock into a larger laundry center frame, as illustrated in the systems in FIGS. 3-6.

The hamper bag frames 3 may be selectively engageable and disengageable from horizontal support bar 5 via the anchor hooks 7 in the process described below such that a user is able to easily transport laundry hamper bags attached to the hamper bag frames to and from the hamper support system 1 as needed.

In operation, the hamper bag frames 3 may be attached to anchor hooks 7 as shown in FIG. 2. Note that FIG. 2 illustrates how a single hamper bag frame 3 is attached to an upper recess 19 in an anchor hook 7. When attaching multiple hamper bag frames 3, as illustrated in the finished product single-bar hamper support system 1 seen in FIG. 1, each of the hamper bag frames 3 may be attached according to the illustration in FIG. 2. FIG. 1 illustrates the process when utilizing rectangular hamper bag frames 3, however hamper bag frames 3 may take substantially any shape, such as a polygonal shape. In the configuration illustrated in FIG. 1, a rectangular hamper bag frame 3 is placed over the top of the anchor hooks 7. A first portion, which may be a shorter side 15 of the rectangular hamper bag frame 3 is placed under the upper section 18 of the anchor hook 7 such that the shorter side 15 of the rectangular hamper bag frame 3 fits into the upper recess 19 in anchor hook 7, and second portions which may be adjacent portions 20 of the hamper bag frame 3 are positioned above the horizontal support bar 5. Preferably, the shorter side 15 of a rectangular hamper bag frame 3 fits into the upper recess 19 of the anchor hook 7 at the midpoint 17 of the shorter side 15. As discussed above, the hamper bag frame 3 may alternatively take substantially any shape and may be attached to the horizontal support bar 5 by placing any portion of the hamper bag frame 3 over the top of the anchor hook 7 and into upper recess 19 of the anchor hook 7 such that the adjacent portions 20 of the hamper bag frame 3 are positioned above the horizontal support bar 5. The structure that results from attaching three rectangular hamper bag frames 3 to the anchor hooks 7 is the illustration of the single-bar hamper support system 1. In this embodiment of the single-bar hamper support system 1, the respective upper recesses 19 of the anchor hooks 7 support the weight of the hamper bag frames 3, the hamper bags, and the contents within the hamper bags.

In one alternative embodiment of the single-bar hamper support system 1, the single-bar hamper support system 1 may include greater than three hamper bag frames 3, and therefore includes greater than three anchor hooks 7, wherein the alternative embodiment includes equal numbers of hamper bag frames 3 and anchor hooks 7.

In a separate alternative embodiment of the single-bar hamper support system 1, attachment pegs 9 are replaced with a screw-receiving hole, such that the single-bar hamper support system 1 may be attached using screws to a larger laundry center frame, in a fashion similar to those illustrated in FIGS. 3-6.

In yet another alternative embodiment of the single-bar hamper support system 1, the hamper bag frames 3 can fit into the upper recess 19 of the anchor hooks 7 such that the hamper bag frames 3 interlock with the anchor hooks 7.

The single-bar hamper support system 1 is designed for preferred use in larger laundry center frames. Four preferred laundry center frames incorporating the single-bar hamper support system 1, or alternatives thereof, are illustrated in FIGS. 3-6.

FIG. 3 illustrates a three-bin gravity hamper 21. The three-bin gravity hamper 21 includes two base horizontal bars 23, two short diagonal bars 29, two long diagonal bars 27, two attaching hinges 31, four wheels 33, single-bar hamper support system 1, three hamper bags 35, and a push handle 37.

The two base horizontal bars 23 are parallel to one another. The front horizontal bar 25 is attached to the base portion 39 of each long diagonal bar 27. The rear horizontal bar 41 is attached to the base portion 43 of each short diagonal bar 29. Two wheels 33 are attached to the bottom portion 45 of each long diagonal bar 27, and two wheels 33 are attached to the bottom portion 47 of each short diagonal bar 29. Preferably, the wheels 33 and base horizontal bars 23 are attached to the long diagonal bars 27 and short diagonal bars 29 using a screw assembly.

Each long diagonal bar 27 is attached to a short diagonal bar 29 at an upper portion 30 of a short diagonal bar 29. Preferably, the long diagonal bar 27 is attached to the short diagonal bar 29 using a screw assembly. An attaching hinge 31 may connect the long diagonal bar 27 and short diagonal bar 29 to allow the three-bin gravity hamper 21 to be collapsible.

The single-bar hamper support system 1 may be connected to the upper portions 49 of each long diagonal bar 27 such that the horizontal support bar 5 of the three-bin hamper support system is parallel to the base horizontal bars 23 and may be positioned above the rear horizontal bar 41. The single-bar hamper support system 1 and upper portions 49 of each long diagonal bar 27 may be attached using attachment pegs 9. Push handle 37 is preferably attached to the top of the long diagonal bars 27 using a screw assembly.

The three hamper bags 35 may be releasably attachable to the hamper bag frames 3.

FIG. 4 illustrates an alternative embodiment of the three-bin gravity hamper 21, a four-bin gravity hamper 51. For the four-bin gravity hamper 51, the single-bar hamper support system 1 illustrated in FIG. 3 may be modified so that it alternatively includes four anchor hooks 7 and four hamper bag frames 3. Also, the four-bin gravity hamper 51 preferably includes four hamper bags 35.

FIG. 5 illustrates another alternative embodiment of the three-bin gravity hamper 21, a three-bin gravity laundry and folding hamper 53. As an alternative to the two short diagonal bars 29 and two long diagonal bars 27 illustrated in FIG. 3, the three-bin gravity laundry and folding hamper 53 illustrated in FIG. 5 includes four diagonal support bars 55. The diagonal support bars 55 in the three-bin gravity laundry and folding hamper 53 may be attached to the base horizontal bars 23 at the lower portion 57 of the diagonal support bars 55. Two of the diagonal support bars 55 are attached to one another to form an X-shaped frame on each of the two sides of the three-bin gravity laundry and folding hamper 53 adjacent to the single-bar hamper support system 1. The two respective pairs of diagonal support bars 55 preferably attach at their intersection point 59. An attaching hinge 31 may connect the diagonal support bars 55 to allow the three-bin gravity laundry and folding hamper 53 to be collapsible.

In the alternative embodiment illustrated in FIG. 5, two top frame members 61 may attach to the top portion 59 of the diagonal support bars 55. A table top 63 may be attached on top of the two top frame members 61. In the preferred embodiment, the table top 63 may be attached using a hinge bracket screw assembly, and it may be attached so as to be parallel to the ground.

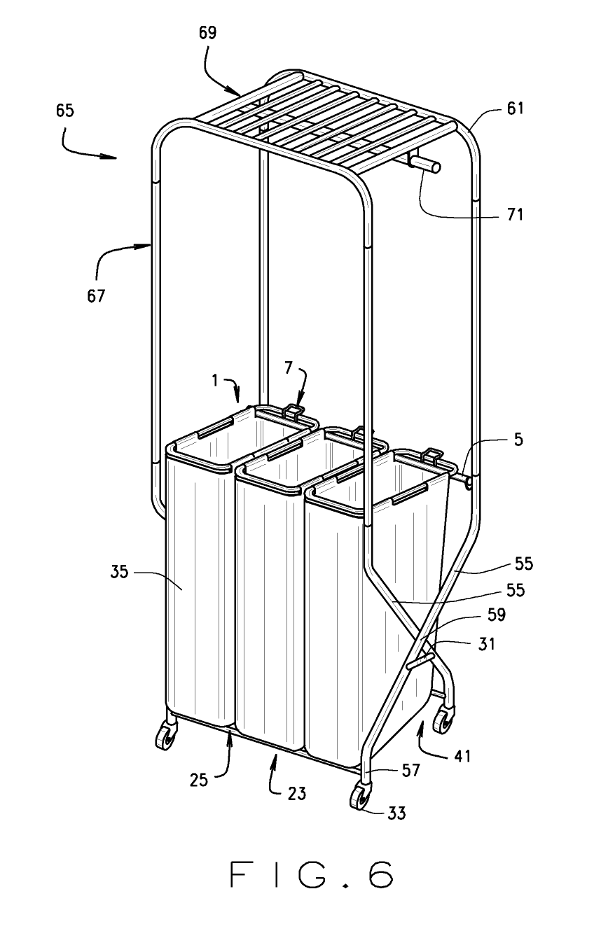

FIG. 6 illustrates a three-bin gravity hamper laundry center 65. The three-bin gravity hamper laundry center 65 is an alternative embodiment of the three-bin gravity laundry and folding hamper 53. In the three-bin gravity hamper laundry center 65, vertical side frame tubes 67 may be connected to the top portions 59 of the diagonal support bars 55 and bottom portions of the top frame members 61. A shelf 69 may be attached to the top frame members 61 as an alternative to table top 63. A hanging tube 71 may be attached to the shelf 69. In the preferred embodiment, the hanging tube 71 is attached to the shelf 69 using a bracket screw assembly.

The laundry center frames attached to single-bar hamper support system 1 illustrated in FIGS. 3-6 may be designed for modularity. Many frame elements found in three-bin gravity hamper 21, four-bin gravity hamper 51, three-bin gravity laundry and folding hamper 53, and three-bin gravity hamper laundry center 65 may be interchangeable. For example, push handle 37, base horizontal bar 23, attaching hinges 31, wheels 33, and single-bar hamper support system 1 may be substituted for one another in any of the laundry center frame embodiments illustrated herein. Long diagonal bars 27 and short diagonal bars 29 may be interchangeable in three-bin gravity hamper 21 and four-bin gravity hamper 51, and diagonal support bars 55 may be interchangeable in three-bin gravity laundry and folding hamper 53 and three-bin gravity hamper laundry center 65. Other frame elements described herein, and any later developed, may be designed to fit into or among any of the laundry center frame embodiments illustrated herein.

Thus, there has been shown and described several embodiments of a novel single-bar hamper support system. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1. A single-bar hamper support system comprising:
a horizontal support bar;
at least one anchor hook, said anchor hook having a vertical portion including an upper section and a lower section, wherein said anchor hook is connected with said horizontal support bar via said lower section;
at least one hamper bag frame, wherein said anchor hook is operable for supporting said hamper bag frame on said horizontal support bar when a first portion of said hamper bag frame is positioned beneath said upper section of said anchor hook, and second portions of said hamper bag frame which are adjacent to said first portion are positioned over said horizontal support bar.

2. The single-bar hamper support system of claim 1 wherein said vertical portion of said anchor hook is generally S-shaped.

3. The single-bar hamper support system of claim 1 wherein said horizontal support bar contains at least two anchor hooks for supporting a corresponding number of hamper bag frames.

4. The single-bar hamper support system of claim 1 wherein said anchor hooks are welded to the horizontal support bar.

5. The single-bar hamper support system of claim 1 wherein said anchor hooks are removeably fastened to said horizontal support bar with selectively removeable fasteners.

6. The single-bar hamper support system of claim 1 wherein attachment pegs are attached to distal ends of said horizontal support bar such that the protruding portions of said attachment pegs are facing radially outward from the horizontal support bar such that said protruding portions may interlock into a larger laundry center frame.

7. The single-bar hamper support system of claim 1 wherein said hamper bag frame is polygonal.

8. The single-bar hamper support system of claim 1 wherein said hamper bag frame is circular.

9. The single-bar hamper support system of claim 1 wherein said anchor hook further has a horizontal portion which extends laterally from the vertical section of the vertical portion to contain said bag frame within the recess of said upper vertical portion of said anchor hook.

10. The single-bar hamper support system of claim 1 wherein said hamper bag frame is rectangular.

11. A single-bar hamper support system comprising:
a horizontal support bar;
at least one anchor hook including a first section extending generally vertically from said horizontal support bar to a distal end of the first section, and a second section extending generally horizontally from the distal end of the first section, said first and second sections of said at least one anchor hook forming a generally L shape;
at least one hamper bag frame positioned on top of said horizontal support bar and below said second section of said at least one anchor hook.
